(19) United States
(12) Patent Application Publication
(10) Pub. No.: US 2008/0244255 A1
(43) Pub. Date: Oct. 2, 2008

(54) Method for not resetting memory while booting computer through hardware booting button thereof

(75) Inventors: Ming-Chih Chen, Taipei Hsien (TW); Wei-Yuan Yang, Taipei Hsien (TW)

Correspondence Address: BRUCE H. TROXELL;SUITE 1404, 5205 LEESBURG PIKE, FALLS CHURCH, VA, 22041, US

(73) Assignee: KINPO ELECTRONICS, INC.

(21) Appl. No.: 11/730,022

(22) Filed: Mar. 29, 2007

(51) Int. Cl. G06F 15/177

(52) U.S. Cl. 713/2

(57) ABSTRACT

A method for not resetting a memory while booting a computer through a hardware booting button is adapted to utilize a general hardware booting mode and increases steps that judges whether preset values are respectively stored in specific address of the memory. If it is the preset value, allowing the memory to be reset is not executed before booting sequences are executed, the booting sequences are directly processed and data stored in the memory is allowed to maintain so that it will not happen that the data stored in the memory is cleared to cause embarrassment to a user because the memory is not reset.

### BACKGROUND OF THE INVENTION

1. Field of the Invention

The present invention relates to a hardware booting button of a computer, and more particularly to a method for allowing a hardware booting button of a computer to have a better function.

2. Description of Related Art

A general computer is provided with a booting button, it allows a computer to execute booting sequences to enable the computer itself to be booted after the booting button is pressed. There are a several patents disclose different functions other than a booting function are provided concurrently when the computer is booted. For example, Taiwan Patent No. 145,352 discloses a computer capable of generating voice while being booted, Taiwan Patent No. 165,643 discloses a computer provided with a booting code improving function and etc.

Computer booting ways of general computers to which a solar energy battery provides power have a software booting mode and a hardware booting mode. Booting the computer by the software booting mode is to allow a booting button to be connected to an I/O port of a computer chip. After the chip detects a signal that the booting button is pressed, it then starts a booting program to cause a computer to be booted. But, it needs to consume more power in a booting instant such that the computer cannot be booted when power of the solar energy battery is weak. Booting the computer by the hardware booting mode is to allow the booting button to be a reset key. After the booting button is pressed, one end thereof is grounded and another end thereof is at a high potential to allow the computer to be booted. Although the hardware booting mode can be used for working out the problem that more power need be consumed in an instant for the software booting mode, a memory is caused to reset after the booting button is pressed such that former stored data cannot be maintained and new data must be input; this causes embarrassment to a user.

### SUMMARY OF THE INVENTION

For allowing a memory not to be reset when a computer is booted through a hardware booting button thereof, the present invention is proposed.

The main object of the present invention is to provide a method for not resetting a memory while booting a computer through a hardware booting button thereof, allowing data in the memory of the computer not to be cleared after the computer is booted.

Another object of the present invention is to provide a method for not resetting a memory while booting a computer through a hardware booting button thereof, allowing not only the computer is easier to be booted, but also data stored in the memory can be maintained so as to increase the computer functionality and practicality.

For attaining to the objects mentioned above, a method for not resetting a memory while booting a computer through a hardware booting button thereof according to the present invention allows data in a memory is maintained at the same time that the computer is booted through a hardware booting mode; it comprises the following steps:
(1) allowing a microprocessor to detect whether there is a message of processing booting sequences;
(2) allowing the microprocessor to detect whether a content of at least one specific address of a memory is a preset value;
(3) if the content of the specific address is not the preset value, the microprocessor then resetting the memory; and
(4) if the content of the specific address is the preset values the microprocessor then executing booting sequences.
   Whereby, it allows the data in the memory is maintained at the same time that the computer is booted to increase the computer functionality and the practicality when a booting button is pressed at next time.

### BRIEF DESCRIPTION OF THE DRAWINGS

The present invention can be more fully understood by reference to the following description and accompanying drawings, in which:

FIG. 1 is a flow chart, showing a method for not resetting a memory while booting a computer through a hardware booting button thereof of a preferred embodiment according to the present invention.

### DETAILED DESCRIPTION OF THE PREFERRED EMBODIMENTS

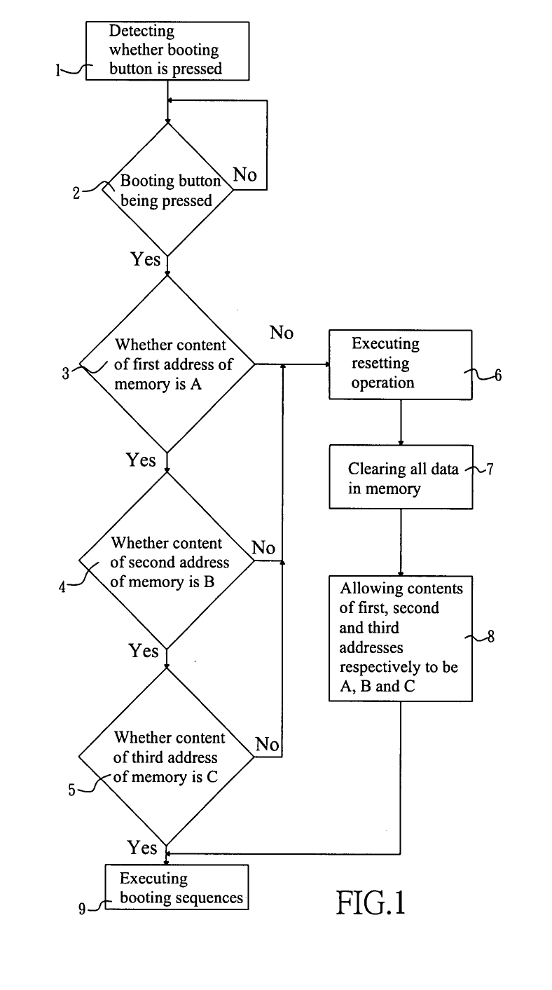

Please refer to FIG. 1. A method for not resetting a memory while booting a computer through a hardware booting button thereof of a preferred embodiment according to the present invention allows data in a memory is maintained at the same time that the computer is booted through a hardware booting mode; it comprises the following steps:

Step 1: allowing a microprocessor in a computer to detect whether there is a message that a booting button is pressed;
Step 2: if the microprocessor detects the message that the booting button is pressed, entering Step 3; if not, then the detecting being continued;
Step 3: allowing the microprocessor to detect whether a content of a first specific address of a memory is a preset value A, if yes, entering Step 4; if not, then entering Step 6;
Step 4: allowing the microprocessor to detect whether a content of a second specific address of a memory is a preset value B, if yes, entering Step 5; if not, then entering Step 6;
Step 5: allowing the microprocessor to detect whether a content of a third specific address of a memory is a preset value C, if yes, entering Step 9; if not, entering Step 6;
Step 6: the microprocessor allowing the memory to be reset;
Step 7: the microprocessor allowing all data in the memory to be cleared;
Step 8: the microprocessor allowing the contents of the first, the second and the third specific addresses in the memory to be respectively set to be the preset values A, B and C; and
Step 9: the microprocessor allowing the computer to execute booting sequences.

The first, the second and the third specific addresses of the memory according to the present invention can respectively be front, middle and rear sections of the memory, and the front, the middle and the rear addresses can respectively be address 11(H), address 55(H) and address FF(H); the preset values A, B and C stored in the memory can be the same values. Specific addresses of the memory according to the present invention are not limited to the first, second and the third specific addresses; they can be more than one specific address. The more preset values are respectively stored in specific addresses, the more the ability that the microprocessor judge whether data stored in the memory is out of the question can be elevated.

The present invention allows a general booting mode to increase the special steps of judging whether the preset values are stored in the specific addresses of the memory. If it is the preset value, the memory is not reset and the data stored in the memory are not cleared before the booting sequences are executed and the booting sequences are directly executed to enable the data stored in the memory to be maintained so that it will not happen that the data stored in the memory are cleared to cause embarrassment to a user and the computer cannot be booted owing to insufficient instant power because the memory is not reset when the computer is on booting. Whereby, the computer is allowed to posses the booting reliability and the use convenience concurrently.

If the preset value of the specific address of the memory is in error according to the present invention, it shows that the data stored in the memory is wrong, the memory is then reset and the recorded data are all cleared. Thereafter, the booting sequences are then processed after the preset value is restored in the specific address to allow the preset values to be respectively stored in the specific addresses and the memory resetting operation not be processed any more to enable the data stored in the memory not to be cleared at next booting. Whereby, the functionality and the practicality of the computer can be elevated.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method for not resetting a memory while booting a computer through a hardware booting button, adapted to allow said computer to maintain data in said memory at the time that a hardware booting mode is adopted to boot said computer, comprising the follow steps:
(1) allowing a microprocessor to detect whether there is a message of processing booting sequences;
(2) allowing said microprocessor to detect whether a content of at least one specific address of said memory is a preset value;
(3) if said content of said specific address is not said preset value, said microprocessor then resetting said memory; and
(4) if said content of said specific address is said preset value, said microprocessor then executing said booting sequences.

2. The method according to claim 1, wherein said microprocessor detects whether said booting button of said computer is pressed in said Step (1).

3. The method according to claim 1, wherein said specific addresses in said Step (2) respectively are preset addresses of front, middle and rear sections of said memory.

4. The method according to claim 3, wherein said front, said middle and said rear addresses of said memory respectively are addresses 11(H), 55(H) and FF(H).

5. The method according to claim 1, wherein said resetting said memory in said Step (3) comprises allowing said microprocessor to clear all data in said memory and reset a content of each said specific address to be said preset value.

6. The method according to claim 2, wherein said resetting said memory in said Step (3) comprises allowing said microprocessor to clear all data in said memory and reset a content of each said specific address to be said preset value.

7. The method according to claim 3, wherein said resetting said memory in said Step (3) comprises allowing said microprocessor to clear all data in said memory and reset a content of each said specific address to be said preset value.
